(19) United States
(12) Patent Application Publication
(10) Pub. No.: US 2021/0205643 A1
(43) Pub. Date: Jul. 8, 2021

(54) FIRE EXTINGUISHING METHOD AND FIRE EXTINGUISHING SYSTEM FOR LITHIUM ION BATTERY, ELECTRONIC DEVICE AND STORAGE MEDIUM

(71) Applicants: CHINA ELECTRIC POWER RESEARCH INSTITUTE COMPANY LIMITED, Beijing. (CN); STATE GRID CORPORATION OF CHINA, Beijing (CN)

(72) Inventors: Kai Yang, Beijing (CN); Fei Gao, Beijing (CN); Kangkang Wang, Beijing (CN); Chaoqun Liu, Beijing (CN); Mingjie Zhang, Beijing (CN); Hao Liu, Beijing (CN); Guangqing Jia, Beijing (CN); Mengmeng Geng, Beijing (CN); Kaifeng Wang, Beijing (CN)

(73) Assignees: CHINA ELECTRIC POWER RESEARCH INSTITUTE COMPANY LIMITED, Beijing (CN); STATE GRID CORPORATION OF CHINA, Beijing (CN)

(21) Appl. No.: 16/486,452

(22) PCT Filed: Jul. 16, 2019
(86) PCT No.: PCT/CN2019/096070

§ 371 Date: Aug. 15, 2019

(30) Foreign Application Priority Data
Jul. 30, 2018 (CN) 201810853120.4

(51) Int. Cl. A62C 3/16; A62C 37/40

(52) U.S. Cl. CPC A62C 3/16; B60L 58/26; A62C 37/40

(57) ABSTRACT

Provided are a fire extinguishing method and a fire extinguishing system for a lithium ion battery, an electronic device and a storage medium. The method includes: real-timely collecting environmental parameter values in a battery box where a lithium ion batteries are placed; determining a safety level of the lithium ion battery according to the environmental parameter values and a preset threshold of each environmental parameter, and sending a fire extinguishing command to a fire extinguishing device according to a preset fire extinguishing control program, where the fire extinguishing control program is a fire extinguishing strategy corresponding to the safety level of the lithium ion battery; and enabling the fire extinguishing device to execute a fire extinguishing operation according to the fire extinguishing command.

### CROSS REFERENCE TO RELATED APPLICATIONS

This is a National Stage Application, filed under 35 U.S.C. 371, of International Patent Application No. PCT/CN2019/096070, filed on Jul. 16, 2019, which claims priority to Chinese patent application No. 201810853120.4 filed on Jul. 30, 2018, contents of both of which are incorporated herein by reference in their entireties.

### TECHNICAL FIELD

The present disclosure is related to the field of lithium battery safety protection and in particular, to a fire extinguishing method and fire extinguishing system for a lithium ion battery, an electronic device and a storage medium.

### BACKGROUND

The lithium ion battery has advantages of large capacity, high operating voltage, long cycle life, small volume, light weight and the like, and is applied to various scenarios. In the electric vehicle and the energy storage system, a power battery for power supply is required to have large capacity and voltage, and multiple unit batteries need to be disposed in a battery box to form a battery pack in series connection or in parallel connection, so as to meet the requirement of a power source. The detection on a lithium ion battery system consisting of battery boxes needs to be strengthened, to reduce or eliminate potential safety hazards.

Due to high energy density and structural characteristics of the battery, once the lithium ion battery burns, the fire is difficult to extinguish. For scenarios in which a large number of batteries are placed in a concentrated manner, such as a battery box, a battery module, a battery shelf and the like, the chain reaction can be caused when the batteries begin to burn, making adjacent batteries ignited successively and finally cause fire. In this case, the burning of the batteries is difficult to extinguish.

For the burning of the lithium ion battery, it cannot be extinguished by adopting a traditional extinguishing technology. The performances of batteries in a battery cabinet, a battery box and a battery unit are different, and when there are fire hazards or open fire, the fire force and the fire intensity are often different. Therefore, if the traditional extinguishing manner is adopted, on one aspect, the fire may possibly not be high-efficiently extinguished completely, and it cannot guarantee that the battery is not be reignited after the open fire is extinguished or a chain reaction does not occur subsequently; and meanwhile, the using amount of the fire extinguishing agent cannot be determined according to the fire intensity, so that its economy performance is not high.

Therefore, a fire extinguishing method and strategy that can not only ensure the effective and complete extinguishing of the open fire of the lithium ion battery but also can save fire extinguishing agent are required.

### SUMMARY

The present disclosure provides a fire extinguishing method and fire extinguishing system for a lithium ion battery, an electronic device and a storage medium, so as to solve the technical problems in the related art that the fire cannot be extinguished effectively and completely, the fire will reignited after the open fire is extinguished and the fire extinguishing agent is wasted in the existing fire extinguishing technology.

The present disclosure provides a fire extinguishing method for a lithium ion battery. The method includes steps described below.

Values of environmental parameters in a battery box where lithium ion batteries are placed are real-timely collected, where the environmental parameters include a temperature, a smoke concentration and a flame intensity.

A safety level of the lithium ion battery is determined according to the values of the environmental parameters and a preset threshold of each of the environmental parameter, and a fire extinguishing command is sent to a fire extinguishing device according to a preset fire extinguishing control program, where the fire extinguishing control program is a fire extinguishing strategy corresponding to the safety level of the lithium ion battery, and the fire extinguishing strategy includes the number of sprayings, a spraying amount of each spraying and a time interval between adjacent sprayings of the fire extinguishing device.

The fire extinguishing device is enabled to execute a fire extinguishing operation according to the fire extinguishing command.

The present disclosure further provides a fire extinguishing system for a lithium ion battery. The system includes a data collection unit, a data transmission unit, a data process unit and a fire extinguishing device.

The data collection unit is configured to real-timely collect values of environmental parameters in a battery box where lithium ion batteries are placed, and send the values of the environmental parameters to the data transmission unit, where the environmental parameters include a temperature, a smoke concentration and a flame intensity.

The data transmission unit is connected to the data collection unit and the data process unit, and is configured to transmit the values of the environmental parameters collected by the data collection unit to the data processing unit.

The data process unit is connected to the data transmission unit, and is configured to determine a safety level of the lithium ion battery according to the values of the environmental parameters and a preset threshold of each of the environmental parameter, and send a fire extinguishing command to a fire extinguishing device according to a pre-written fire extinguishing control program, where the fire extinguishing control program is a fire extinguishing strategy corresponding to the safety level of the lithium ion battery, and the fire extinguishing strategy includes the number of sprayings, a spraying amount of each spraying and a time interval between adjacent sprayings of the fire extinguishing device.

The fire extinguishing device is configured to execute a fire extinguishing operation according to the fire extinguishing command of the data process unit.

The present disclosure further provides an electronic device.

The electronic device includes at least one processor, and a memory, which is configured to store a fire extinguishing program.

When executed by the at least one processor, the at least one fire extinguishing program enables the at least one processor to implement the fire extinguishing method described above.

The present disclosure further provides a computer-readable storage medium, which is configured to store computer-executable instructions for executing the fire extinguishing method described above.

### BRIEF DESCRIPTION OF DRAWINGS

Exemplary embodiments of the present disclosure will be more fully understood with reference to the following drawings.

FIG. 1 is a flowchart of a fire extinguishing method for a lithium ion battery according to an optional embodiment of the present disclosure.

FIG. 2 is a structural diagram of a fire extinguishing system for a lithium ion battery according to an optional embodiment of the present disclosure.

FIG. 3 is a structural diagram of an electronic device according to an optional embodiment of the present disclosure.

### DETAILED DESCRIPTION

Exemplary embodiments of the present disclosure will now be described with reference to the drawings. However, this disclosure may be embodied in many different forms and should not be construed as limited to the embodiments described herein. The terms used in the exemplary embodiments illustrated in the drawings do not limit the present disclosure. In the drawings, the same units/elements use the same reference numbers in the drawings.

Unless otherwise defined, all terms (including technical terms) used herein have the same meanings as the terms commonly understood by those skilled in the art. In addition, it should be understood that the terms defined in the commonly used dictionaries have consistent meanings with the terms in the existing art, and shall not be understood in an idealized or overly formal sense.

FIG. 1 is a flowchart of a fire extinguishing method for a lithium ion battery according to an optional embodiment of the present disclosure. As shown in FIG. 1, this optional embodiment provides a fire extinguishing method 100 for a lithium ion battery. The method 100 begins with step 101.

In step 101, thresholds of environmental parameters: a threshold Yₜ of the temperature T, a threshold Yₛ of the smoke concentration S and a threshold Y_{f} of the flame intensity F are set according to types and energy levels of lithium ion batteries.

A safety level of a fire extinguishing system may be determined according to thresholds of all environmental parameters.

The safety level is level one based on a determination result of F>Y_{f}.

The safety level is level two based on a determination result of F≤Y_{f} and T>Yₜ or based on a determination result of F≤Y_{f} and S>Yₛ.

The safety level is level three based on a determination result of F≤Y_{f}, T≤Yₜ and S≤Yₛ.

The fire extinguishing control program includes steps described below.

Based on the determination result that the safety level is level one, the fire extinguishing device is enabled to extinguish open fire in a battery box where a fired lithium ion batteries are placed according to the set first number of sprayings, a set first spraying amount of the each spraying and a first time interval between adjacent sprayings of the fire extinguishing device, and to cool an interior of the battery box according to the set first number of sprayings, a set first spraying amount of the each spraying and the first time interval between adjacent sprayings of the fire extinguishing device.

Based on the determination result that the safety level is level two, the fire extinguishing device is enabled to cool an interior of the battery box where the lithium ion batteries are placed according to the set second number of sprayings, a set second spraying amount of the each spraying and a second time interval between adjacent sprayings of the fire extinguishing device. Based on the determination result that the safety level is level three, the fire extinguishing device is enabled not to execute a fire extinguishing operation.

In step 102, values of environmental parameters in the battery box where the lithium ion batteries are placed are real-timely collected, where the environmental parameters include a temperature, a smoke concentration and a flame intensity.

Optionally, the step in which the values of the environmental parameters in the battery box where the lithium ion batteries are placed are real-timely collected means that a temperature, a smoke concentration and a flame intensity in the battery are real-timely detected through a temperature sensor, a smoke sensor and a flame sensor disposed in the battery box where the lithium ion batteries are placed, and the detected temperature, the detected smoke concentration and the detected flame intensity in the battery are converted into identifiable signals.

In step 103, a safety level of the lithium ion battery is determined according to the values of the environmental parameters and a preset threshold of each of the environmental parameters, and a fire extinguishing command is sent to a fire extinguishing device according to a preset fire extinguishing control program, where the fire extinguishing control program is a fire extinguishing strategy corresponding to the safety level of the lithium ion battery, and the fire extinguishing strategy includes the number of sprayings, each spraying amount and a time interval between adjacent sprayings of the fire extinguishing device.

In step 104, the fire extinguishing device is enabled to execute a fire extinguishing operation according to the fire extinguishing command.

In this optional embodiment, when the temperature of the battery rises to be greater than or equal to 65□ or the smoke sensor senses that the smoke concentration reaches a threshold, a fire extinguishing control program corresponding to the safety level two is initiated to cool the battery. At the moment, a cooling-type fire extinguishing agent is started, changes of the battery temperature and a temperature around the battery are determined through the temperature sensor, and spraying is stopped when the temperature drops below 65□.

When the flame sensor in the battery box detects open fire, a fire extinguishing control program corresponding to the safety level one is started to reduce oxygen content in the air and inhibit fire from spreading. At the moment, a smothering-type fire extinguishing agent is started to extinguish fire, and whether the open fire is extinguished is determined through the flame sensor. The space around the battery is closed after the flame of the battery is extinguished initially, and the smothering-type fire extinguishing agent is continuously sprayed. After the battery cabinet is filled with the smothering-type fire extinguishing agent, the spraying is stopped for 5 to 10 minutes. During this period, the cooling-type fire extinguishing agent is continuously sprayed. If the battery is reignited during this period, the smothering-type fire extinguishing agent is restarted until the fire is extinguished again. After that, wait for 5 to 10 minutes, and then, a fan is started or the battery cabinet is opened to dissipate the heat generated by burning in the cabinet. Whether the temperature of the battery in the cabinet is reduced to a threshold is determined through the temperature sensor. After the battery temperature is reduced to the threshold, the battery temperature is continuously monitored. In condition that the battery temperature rises, the cooling-type fire extinguishing agent is continuously sprayed until the battery temperature begins to be reduced. When the battery temperature is reduced to be lower than the threshold and the temperature does not rise, after 30 mins to one hour, the fan is started or the cabinet is opened and people are prevented from approaching the cabinet. The temperature is continuously detected through the temperature sensor until the battery temperature is reduced to the room temperature. The fire disaster state is released.

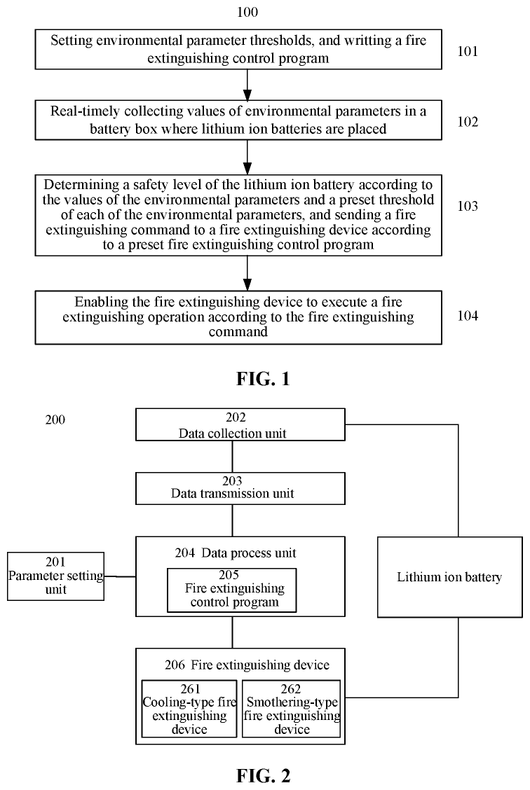

FIG. 2 is a structural diagram of a fire extinguishing system for a lithium ion battery according to an optional embodiment of the present disclosure. As shown in FIG. 2, the fire extinguishing system 200 for a lithium ion battery described in this optional embodiment includes a data collection unit, a data transmission unit, a data process unit and a fire extinguishing device.

A parameter setting unit 201 is configured to set a threshold Yₜ of a temperature T, a threshold Yₛ of a smoke concentration S and a threshold Y_{f} of a flame intensity F according to a type and an energy level of the lithium ion battery, and determine a safety level of the fire extinguishing system according to thresholds of all environmental parameters.

The safety level is level one when F>Y_{f}.

The safety level is level two when F≤Y_{f} and T>Yₜ or when F≤Y_{f} and S>Yₛ.

The safety level is level three when F≤Y_{f}, T≤Yₜ and S≤Yₛ.

The data collection unit 202 is configured to real-timely collect values of the environmental parameters in a battery box where a lithium ion batteries are placed, and send the values of the environmental parameters to the data transmission unit, where the environmental parameters include a temperature, a smoke concentration and a flame intensity.

The data transmission unit 203 is connected to the data collection unit and the data process unit, and is configured to transmit the values of the environmental parameters collected by the data collection unit to the data processing unit.

The data process unit 204 is connected to the data transmission unit, and is configured to determine a safety level of the lithium ion battery according to the values of the environmental parameters and a preset threshold of each of the environmental parameters, and send a fire extinguishing command to a fire extinguishing device according to a pre-written fire extinguishing control program, where the fire extinguishing control program 205 is a fire extinguishing strategy corresponding to the safety level of the lithium ion battery, and the fire extinguishing strategy includes the number of sprayings, a spraying amount of each spraying and a time interval between adjacent sprayings of the fire extinguishing device.

The fire extinguishing device 206 is configured to execute a fire extinguishing operation according to the fire extinguishing command of the data process unit.

Optionally, the data collection unit 202 includes a temperature sensor, a smoke sensor and a flame sensor.

It is to be noted that the temperature sensor is configured to real-timely detect a temperature in the battery, the smoke sensor is configured to real-timely detect a smoke concentration in the battery, and the flame sensor is configured to real-timely detect a flame intensity in the battery.

Optionally, the fire extinguishing control program 205 includes steps described below.

Based on the determination result that the safety level is level one, the fire extinguishing device is enabled to extinguish open fire in the battery box where fired lithium ion batteries are placed according to the set number of sprayings, a spraying amount of each spraying and a time interval between adjacent sprayings of the fire extinguishing device, and to cool an interior of the battery box according to the set number of sprayings, a spraying amount of each spraying and the time interval between adjacent sprayings of the fire extinguishing device.

Based on the determination result that the safety level is level two, the fire extinguishing device is enabled to cool the interior of the battery box where the lithium ion batteries are placed according to the set number of sprayings, a spraying amount of each spraying and a time interval between adjacent sprayings of the fire extinguishing device.

Based on the determination result that the safety level is level three, the fire extinguishing device is enabled not to execute the fire extinguishing operation.

Optionally, the fire extinguishing device 206 includes a cooling-type fire extinguishing device 261 and a smothering-type fire extinguishing device 262.

The cooling-type fire extinguishing device 261 is configured to cool the interior of the battery box where the lithium ion batteries are placed.

The smothering-type fire extinguishing device 262 is configured to extinguish open fire in the battery box by spraying a smothering-type fire extinguishing agent in the battery box where the fired lithium ion batteries are placed.

Optionally, the number of fire extinguishing devices in the fire extinguishing system and the number of data collection units are determined according to the types and the energy levels of the lithium ion batteries.

In this optional embodiment, two bottles of fire extinguishing agents are configured for a 10 kWh lithium ion battery box. One of the two bottles of fire extinguishing agents is a cooling-type fire extinguishing agent (e.g., dry ice), and the other of two bottles of fire extinguishing agents is a smothering-type fire extinguishing agent (e.g., heptafluoropropane). More than two temperature sensors are disposed in a battery pack in the battery box. A smoke sensor and a flame sensor are disposed at the top of the battery box, two cooling-type fire extinguishing agent spraying probes and two smothering-type fire extinguishing agent spraying probes are disposed at four corners of the top of the battery box.

In this optional embodiment, a 1 MWh lithium ion battery system in the energy storage power station includes ten cabinets. Each cabinet is a 0.1 MWh battery module. The whole battery system is provided with two sets of fire extinguishing systems. One set of fire extinguishing system is a cooling-type fire extinguishing system (e.g., a water mist fire extinguishing system) consisting of multiple cooling-type fire extinguishing devices, and the other set of fire extinguishing system is a smothering-type fire extinguishing system (e.g., perfluorinated ketone) consisting of multiple smothering-type fire extinguishing devices. In each cabinet, more than two temperature sensors are disposed in each battery box. A smoke sensor and a flame sensor are disposed at the top of the battery box, two cooling-type fire extinguishing agent spraying probes and two smothering-type fire extinguishing agent spraying probes are disposed at four corners of the top of the battery box.

In this optional embodiment, for a container-type 1 MWh lithium ion battery system, a battery cabinet is disposed in the container. The whole battery system is provided with two sets of fire extinguishing systems. One set is a cooling-type fire extinguishing system (e.g., a water mist fire extinguishing system) consisting of multiple cooling-type fire extinguishing devices, and the other set is a smothering-type fire extinguishing system (e.g., perfluorinated ketone) consisting of multiple smothering-type fire extinguishing devices. In each cabinet, more than two temperature sensors are disposed in each battery box. A smoke sensor and a flame sensor are disposed at the top of the battery box, two cooling-type fire extinguishing agent spraying probes and two smothering-type fire extinguishing agent spraying probes are disposed at four corners of the top of the battery box.

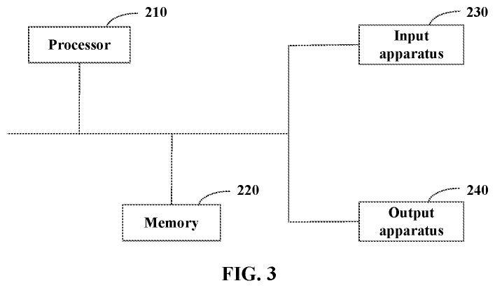

FIG. 3 is a structural diagram of hardware of an electronic device according to an embodiment. As shown in FIG. 3, the electronic device includes: one or more processors 210 and a memory 220. FIG. 3 shows one processor 210 by way of example.

The electronic device may further include an input apparatus 230 and an output apparatus 240.

The processor 210, the memory 220, the input apparatus 230 and the output apparatus 440 in the electronic device may be connected via a bus or in other manners, with connection via a bus as an example in FIG. 3.

As a computer-readable storage medium, the memory 220 may be configured to store software programs and computer-executable programs and modules. The processor 210 runs the software programs, instructions and modules stored in the memory 220 to perform function applications and data processing, that is, to implement any method in the above-mentioned embodiments.

The memory 220 may include a program storage region and a data storage region, where the program storage region may store an operating system and an application program required by at least one function while the data storage region may store data created according to use of an electronic device. In addition, the memory may include a volatile memory, such as a random access memory (RAM), and may also include a nonvolatile memory, such as at least one dick memory, a flash memory or other nonvolatile solid-state memories.

The memory 220 may be a non-transient computer storage medium or a transient computer storage medium. The non-transient computer storage medium includes, for example, at least one disk memory, a flash memory or another nonvolatile solid-state memory. In some embodiments, the memory 220 optionally includes memories which are remotely disposed relative to the processor 210 and these remote memories may be connected to the electronic device via a network. Examples of such a network may include the Internet, intranets, local area networks, mobile communication networks, and combinations thereof.

The input apparatus 230 may be configured to receive inputted digital or character information and generate key signal input related to user settings and function control of the electronic device. The output device 240 may include display apparatuses such as a display screen.

Embodiments of the present disclosure further provide a computer-readable storage medium, which is configured to store computer-executable instructions for executing the method described above.

All or part of the procedure processes in the methods of the above-mentioned embodiments may be implemented by related hardware executed by computer programs, these programs may be stored in a non-transient computer-readable storage medium, and during the execution of these programs, the processes in the above method embodiments may be implemented. The non-transient computer-readable storage medium may be a magnetic disk, an optical disk, a read-only memory (ROM) or an RAM. Generally, all terms used in the claims are to be interpreted according to their ordinary meaning in the art, unless explicitly defined otherwise herein. All references to “a/the [apparatus, component, etc.]” are to be interpreted openly as referring to at least one instance of the apparatus, component, etc., unless explicitly stated otherwise. The steps of any method disclosed herein do not have to be performed in the exact order disclosed, unless explicitly stated otherwise.

In the fire extinguishing method and a fire extinguishing system for lithium ion batteries provided by the technical solution of the present disclosure, environmental parameters in a battery box where lithium ion batteries are placed are real-timely collected, a safety level of the lithium ion battery is determined by comparing with set environmental parameter thresholds, a fire extinguishing command is sent according to a fire extinguishing strategy corresponding to the safety level in a pre-written fire extinguishing control program, a fire extinguishing device is enabled to cool the interior of the battery box and/or extinguish open fire according to the number of sprayings, the a spraying amount of each spraying and the time interval between the sprayings of the fire extinguishing device set by the corresponding fire extinguishing strategy. Compared with the related art, for battery packs with different battery types and energy levels, the present disclosure may real-timely collect values of the environmental parameters, determine the safety level of the battery by comparing with set environmental parameter thresholds, and extinguish the fire according to fire extinguishing strategies corresponding to different safety level in the pre-written fire extinguishing control program. Therefore, the open fire can be rapidly extinguished, the re-ignition of open fire can be effectively prevented, and the fire extinguishing device is precisely controlled through the fire extinguishing control program so as to maximally save the fire extinguishing agent.

What is claimed is:

1. A fire extinguishing method for a lithium ion battery, comprising:
real-timely collecting values of environmental parameters in a battery box where lithium ion batteries are placed, wherein the environmental parameters comprise a temperature, a smoke concentration and a flame intensity;
determining a safety level of the lithium ion battery according to the values of the environmental parameters and a preset threshold of each of the environmental parameters, and sending a fire extinguishing command to a fire extinguishing device according to a preset fire extinguishing control program, wherein the fire extinguishing control program is a fire extinguishing strategy corresponding to the safety level of the lithium ion battery, and the fire extinguishing strategy comprises a number of sprayings, a spraying amount of each spraying, and a time interval between adjacent sprayings of the fire extinguishing device; and
enabling the fire extinguishing device to execute a fire extinguishing operation according to the fire extinguishing command.

2. The fire extinguishing method of claim 1, wherein before the real-timely collecting the values of the environmental parameters in the battery box where the lithium ion batteries are placed, the method further comprises:
setting a threshold Yₜ of the temperature T, a threshold Yₛ of the smoke concentration S and a threshold Y_{f} of the flame intensity F in the environmental parameters according to types and energy levels of the lithium ion batteries;
the determining the safety level of the lithium ion battery according to the values of environmental parameters and the preset threshold of each of the environmental parameters comprises:
determining that the safety level is level one based on a determination result of F>Y_{f}, determining that the safety level is level two based on a determination result of F≤Y_{f} and T>Yₜ or based on a determination result of F≤Y_{f} and S>Yₛ; and
determining that the safety level is level three based on a determination result of F≤Y_{f}, T≤Yₜ and S≤Yₛ; and
the fire extinguishing control program comprises:
based on the determination result that the safety level is level one, enabling the fire extinguishing device to extinguish open fire in the battery box where fired lithium ion batteries are placed according to a set first number of sprayings, a set first spraying amount of the each spraying, and a set first time interval between the adjacent sprayings of the fire extinguishing device, and to cool an interior of the battery box according to the set first number of sprayings, the set first spraying amount of the each spraying and the set first time interval between the adjacent sprayings of the fire extinguishing device;
based on the determination result that the safety level is level two, enabling the fire extinguishing device to cool the interior of the battery box where the lithium ion batteries are placed according to a set second number of sprayings, a set second spraying amount of the each spraying and a set second time interval between the adjacent sprayings of the fire extinguishing device; and
based on the determination result that the safety level is level three, enabling the fire extinguishing device not to execute the fire extinguishing operation.

3. The fire extinguishing method of claim 1, wherein the real-timely collecting the values of environmental parameters in the battery box where the lithium ion batteries are placed comprises: real-timely detecting the temperature, the smoke concentration and the flame intensity in the battery box through a temperature sensor, a smoke sensor and a flame sensor disposed in the battery box where the lithium ion batteries are placed, and converting the detected temperature, the detected smoke concentration and the detected flame intensity in the battery into identifiable signals.

4. A fire extinguishing system for a lithium ion battery, comprising: a data collection unit, a data transmission unit, a data process unit and a fire extinguishing device; wherein
the data collection unit is configured to real-timely collect values of environmental parameters in a battery box where a lithium ion batteries are placed, and send the values of environmental parameters to the data transmission unit, wherein the environmental parameters comprise a temperature, a smoke concentration and a flame intensity;
wherein the data transmission unit is connected to the data collection unit and the data process unit, and is configured to transmit the values of the environmental parameters collected by the data collection unit to the data processing unit;
wherein the data process unit is connected to the data transmission unit, and is configured to determine a safety level of the lithium ion battery according to the values of the environmental parameters and a preset threshold of each of the environmental parameters, and send a fire extinguishing command to a fire extinguishing device according to a pre-written fire extinguishing control program, wherein the pre-written fire extinguishing control program is a fire extinguishing strategy corresponding to the safety level of the lithium ion battery, and the fire extinguishing strategy comprises a number of sprayings, a spraying amount of each spraying, and a time interval between adjacent sprayings of the fire extinguishing device; and
wherein the fire extinguishing device is configured to execute a fire extinguishing operation according to the fire extinguishing command of the data process unit.

5. The fire extinguishing system of claim 4, wherein the data collection unit comprises a temperature sensor, a smoke sensor and a flame sensor;
wherein the temperature sensor is configured to real-timely detect a temperature in the battery box;
wherein the smoke sensor is configured to real-timely detect a smoke concentration in the battery box; and
wherein the flame sensor is configured to real-timely detect a flame intensity in the battery box.

6. The fire extinguishing system of claim 4, wherein the system further comprises a parameter setting unit, which is configured to set a threshold Yₜ of the temperature T, a threshold Yₛ of the smoke concentration S and a threshold Y_{f} of the flame intensity F according to types and energy levels of the lithium ion batteries.

7. The fire extinguishing system of claim 6, wherein the fire extinguishing control program comprises:
based on a determination result that the safety level is level one, enabling the fire extinguishing device to extinguish open fire in the battery box where fired lithium ion batteries are placed according to a set first number of sprayings, a set first spraying amount of each spraying and a set first time interval between adjacent sprayings of the fire extinguishing device, and to cool an interior of the battery box according to the set first number of sprayings, the set first spraying amount of the each spraying and the set first time interval between the adjacent sprayings of the fire extinguishing device;
based on a determination result that the safety level is level two, enabling the fire extinguishing device to cool an interior of the battery box where the lithium ion batteries are placed according to a set second number of sprayings, a set second spraying amount of the each spraying and a set second time interval between adjacent sprayings of the fire extinguishing device; and
based on a determination result that the safety level is level three, enabling the fire extinguishing device not to execute the fire extinguishing operation.

8. The fire extinguishing system of claim 4, wherein the fire extinguishing device comprises:
a cooling-type fire extinguishing device, which is configured to cool an interior of the battery box where the lithium ion batteries are placed; and
a smothering-type fire extinguishing device, which is configured to extinguish open fire in the battery box by spraying a smothering-type fire extinguishing agent in the battery box where the fired lithium ion batteries are placed.

9. The fire extinguishing system of claim 4, wherein a number of fire extinguishing devices in the fire extinguishing system and a number of data collection units in the fire extinguishing system are determined according to types and energy levels of the lithium ion batteries.

10. An electronic device, comprising:
at least one processor; and
a memory, which is configured to store at least one fire extinguishing program; wherein
when executed by the at least one processor, the at least one fire extinguishing program enables the at least one processor to implement the fire extinguishing method, and the fire extinguishing method comprises:
real-timely collecting values of environmental parameters in a battery box where lithium ion batteries are placed, wherein the environmental parameters comprise a temperature, a smoke concentration and a flame intensity;
determining a safety level of the lithium ion battery according to the values of the environmental parameters and a preset threshold of each of the environmental parameters, and sending a fire extinguishing command to a fire extinguishing device according to a preset fire extinguishing control program, wherein the fire extinguishing control program is a fire extinguishing strategy corresponding to the safety level of the lithium ion battery, and the fire extinguishing strategy comprises a number of sprayings, a spraying amount of each spraying, and a time interval between adjacent sprayings of the fire extinguishing device; and
enabling the fire extinguishing device to execute a fire extinguishing operation according to the fire extinguishing command.

11. A non-transitory computer-readable storage medium, which is configured to store computer-executable instructions for executing the fire extinguishing method of claim 1.

12. The fire extinguishing method of claim 2, wherein the real-timely collecting the values of environmental parameters in the battery box where the lithium ion batteries are placed comprises: real-timely detecting the temperature, the smoke concentration and the flame intensity in the battery box through a temperature sensor, a smoke sensor and a flame sensor disposed in the battery box where the lithium ion batteries are placed, and converting the detected temperature, the detected smoke concentration and the detected flame intensity in the battery into identifiable signals.
